(19) United States
(12) Patent Application Publication
(10) Pub. No.: US 2010/0051255 A1
(43) Pub. Date: Mar. 4, 2010

(54) HEAT EXCHANGER, PARTICULARLY FOR A MOTOR VEHICLE

(75) Inventors: Karsten Emrich, Stuttgart (DE); Heinz Czemmel, Rutesheim (DE); Waldemar Friesenhahn, Kornwestheim (DE); Timm Roeschmann, Stuttgart (DE)

Correspondence Address: LEYDIG VOIT & MAYER, LTD, 700 THIRTEENTH ST. NW, SUITE 300, WASHINGTON, DC, 20005-3960, US

(73) Assignees: BEHR GMBH & CO. KG, Stuttgart (DE); BEHR THERMOT-TRONIK GMBH, Kornwestheim (DE)

(21) Appl. No.: 12/513,170

(22) PCT Filed: Nov. 6, 2007
(86) PCT No.: PCT/EP07/09582

§ 371 Date: May 14, 2009

(30) Foreign Application Priority Data
Nov. 6, 2006 (DE) 10 2006 052 526.4

(51) Int. Cl. G05D 23/01

(52) U.S. Cl. 165/300

(57) ABSTRACT

The invention relates to a heat exchanger, particularly for a motor vehicle, comprising a housing (2) with a connection (4) for the inlet or outlet of a first fluid, wherein the first fluid can flow through the housing (2), and wherein exchange means (1) are disposed in the housing (2), the second fluid flowing through these means, wherein the first fluid flows through a control member (7), by means of which the flow of the first fluid can be varied, wherein the connection (4) has a molding (6) for retaining the control member (7).

The present invention relates to a heat exchanger, particularly for a motor vehicle, according to the preamble of Claim 1.

In the construction of heat exchangers for motor vehicles, there exist innovations, such as, e.g., exhaust-gas coolers for cooling exhaust gas that has been recirculated for reducing pollutants in an internal combustion engine. Here, there have been demands not only for basic functioning systems, but also for the reduction of costs by decreasing the number of components and assembly expense.

It is known to provide heat exchangers, such as, e.g., exhaust-gas coolers, with a thermostat for regulating a coolant flow. The thermostat must be mounted in the coolant lines by means of suitable adapters. This produces expense with respect to assembly and the number of required components.

The task of the invention is to specify a heat exchanger, particularly for a motor vehicle, for which the production costs and the assembly expense are reduced.

For the heat exchanger mentioned above, this task is achieved according to the invention with the characterizing features of Claim 1. By providing a suitable formation on the connection of the housing, the attachment of a control element is possible in an especially easy way and the number of components required for integrating a control element into the fluid circuit is reduced.

In a preferred construction, the control element is a thermostat with thermomechanical adjustment of the fluid flow. Thermomechanical is to be understood in that a temperature change in the fluid has a direct, mechanical effect on the adjustment, for example, through changes in length in the suitable components. Here, the thermostat preferably has an expansion element. Such expansion elements, e.g., based on wax, are common and well suited for thermostat controllers. In principle, however, other suitable components, such as, for example, bimetal strips, memory metals, or the like could also be used.

In a preferred improvement, the thermostat could also be formed as a characteristic diagram thermostat. Such characteristic diagram thermostats feature, in principle, thermomechanical regulation, e.g., by means of expansion elements, wherein this regulation can be influenced in its characteristic line by means of an additional electrical heater. In this way, a fine optimization of the regulation characteristics of the control element can be easily achieved, wherein the basic function is guaranteed even for the loss of the electrical effect.

For further simplification, it is advantageously provided that a spring of the control element is supported against the connection of the housing. In this way, the connection of the housing or its formation adapted to the setting of the control element is included as a functional component of the control element, so that, in particular, extensive materials and components can be spared and the required installation space is reduced.

Preferably, sealing means are arranged on the formation, in order to guarantee reliable sealing of the fluid flow when the control element is mounted.

In general, the connection is advantageously formed as a tubular connecting piece, wherein the formation has a laterally projecting collar of the connecting piece. Such a laterally projecting collar can be formed according to detailed formation as a flange permitting screwing or as a component of a locking or positive-fit closure. In a preferred construction, the control element can be fixed in a locking way on the formation. This can be realized, e.g., by means of elastic hooks that are pushed over the formation or laterally projecting collar of the connecting piece and engage in an undercutting manner. Alternatively or additionally, the control element could also be formed like a kind of bayonet catch on the formation, wherein the mounting is performed in a positive-fit way by means of an axial and simultaneously superimposed rotational movement. Any other conceivable type of simple mounting of the control element on the formation is also possible, for example, by means of clamps, clips, retaining rings, etc. For example, the formation is also formed as a thread, so that the control element is screwed directly onto the formation.

In general, the housing is advantageously made from a plastic, wherein the formation is formed with the same material integrally with the housing. This can take place in a simple way in that the housing is produced as an injection molded part. Thus, the preparation of a formation for mounting the control element requires only a one-time expense for the shaping of the injection mold.

A heat exchanger according to the invention is especially suitable in a formation as an exhaust-gas cooler, wherein the second fluid is made at least partially from exhaust gas of an internal combustion engine. The first fluid is preferably a coolant of a cooling circuit of a combustion engine. For such a use it is desired that the coolant that branches, e.g., from the coolant circuit of the internal combustion engine, is protected by the control element from too much heat input by the exhaust gas, in order to avoid overheating of the internal combustion engine by the exhaust-gas cooling.

Additional advantages and features of the invention follow from the embodiment described below and also from the dependent claims.

Then a preferred embodiment of a device according to the invention will be described and explained in more detail with reference to the accompanying drawings.

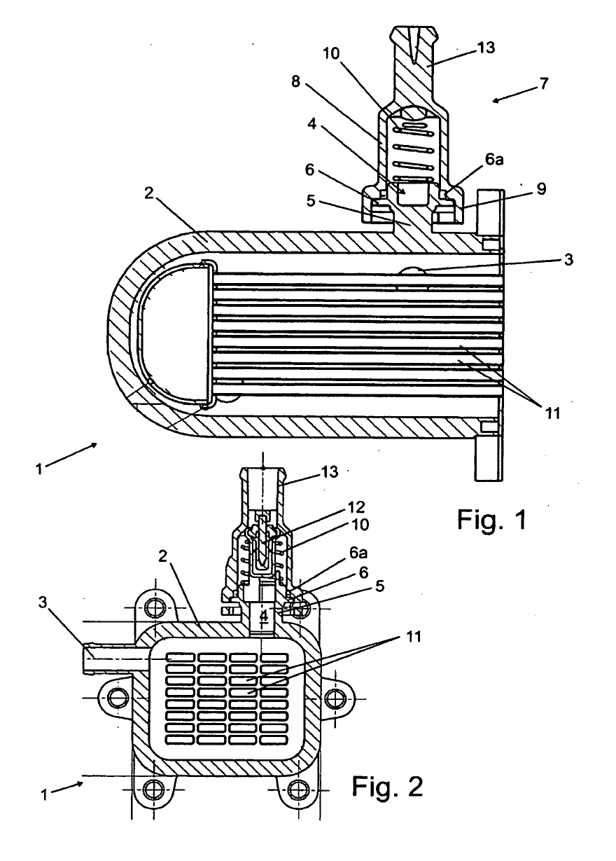

FIG. 1 shows a schematic sectional diagram of a heat exchanger with a control element provided on the exchanger.

FIG. 2 shows a top view of the heat exchanger from FIG. 1 from the front.

The heat exchanger 1 shown in FIG. 2 is an exhaust-gas cooler for an internal combustion engine that has an outer housing 2 produced as a plastic injection-molded part. The housing 2 surrounds the exchanger means 11 like a water-cooling jacket, wherein these means are formed as a bundle of flat tubes made from stainless steel. In their interior, the flat tubes 11 guide the flow of hot exhaust gases of an internal combustion engine, wherein the exhaust-gas flow is cooled by means of coolant circulating in the housing 2 and flowing around the exchanger tubes 11. For this purpose, the housing 2 has two connections 3, 4 for feeding and discharging the coolant. One connection 3 is here formed as a simple tube-like connecting piece for attaching a flexible hose line. The other connection 4 has a tube-like connecting piece 5 and a formation 6 that is formed as a lateral, flange-like projecting collar of the connecting piece 5. For positioning a sealing ring, the projecting collar 6 has suitable steps 6a.

A control element 7 is formed as a thermostat with an expansion element as a functionally essential component and mounts directly on the formation 6 of the connecting piece 5 of the connection 4. Mounting is performed by means of a correspondingly formed housing 8 made from plastic that has a connection region 9 corresponding to the projecting collar 6 like a cap gripping over the formation 6. Within the housing 8, a thermostat mechanism 12 is arranged with an expansion element in a known way. Here, the thermostat mechanism 12 is supported by means of a spring 10 against the connection, so that, with its formation 6, the connection 4 forms a functional component of the control element 7.

On its side opposite the connection 4, the control element has a pipe connecting piece 13 that corresponds in shape to the connection 3 of the housing 2 and that is used for simple attachment of a flexible hose line in a known way. Thus, the control element 7 is integrated serially in the coolant flow and mounted directly on the housing 2 formed integrally with the same material, wherein the housing 2 has a specially adapted formation 6 for interacting with the control element 7.

In principle, the control element could be arranged on the inlet side or also on the outlet side of the housing 2. A different passage cross section of the control element 7 is set according to the temperature of the coolant. Thus, the control element could be used, for example, for preventing overheating of the internal combustion engine, if too large a quantity of heat is output from the exhaust gas via the heat exchanger into the coolant.

1. A heat exchanger for a motor vehicle, comprising a housing with a connection for an inlet or an outlet of a first fluid, wherein the housing can carry the flow of a first fluid and wherein, in the housing, exchange means for carrying a flow of a second fluid are arranged, wherein the first fluid flows through a control element by means of which the flow of the first fluid can be changed, wherein the connection has a formation for holding the control element.

2. The heat exchanger according to claim 1, wherein the control element is a thermostat with a thermomechanical setting of the fluid flow.

3. The heat exchanger according to claim 2, wherein the thermostat has an expansion element.

4. The heat exchanger according to claim 2 wherein the thermostat is a characteristic diagram thermostat.

5. The heat exchanger according to claim 1, wherein the control element includes a spring supported against the connection of the housing.

6. The heat exchanger according to claim 1, comprising sealing means arranged on the formation.

7. The heat exchanger according to claim 1, wherein the connection is formed as a tubular connecting piece, and the formation has a laterally projecting collar of the connecting piece.

8. The heat exchanger according to claim 1, wherein the control element is screwed together with the formation.

9. The heat exchanger according to claim 1, wherein the control element is mounted on the formation.

10. The heat exchanger according to claim 1, wherein the control element is mounted as a bayonet closure on the formation.

11. The heat exchanger according to claim 1, wherein the housing and formation are plastic, and the formation is formed integrally with the housing.

12-13. (canceled)
